(19) United States
(12) Patent Application Publication
(10) Pub. No.: US 2023/0348081 A1
(43) Pub. Date: Nov. 2, 2023

(54) AIRCRAFT HAVING A DRIVE-AND-ENERGY SYSTEM FOR LOW-EMISSION CRUISING FLIGHT

(71) Applicant: DEUTSCHE AIRCRAFT GMBH, Wessling (DE)

(72) Inventors: Carsten RIEDIGER, Herrsching (DE); Martin NUSSELER, Oberostendorf (DE)

(21) Appl. No.: 18/030,156

(22) PCT Filed: Sep. 23, 2021
(86) PCT No.: PCT/DE2021/100772

§ 371 Date: Apr. 4, 2023

(30) Foreign Application Priority Data
Oct. 5, 2020 (DE) 10 2020 126 045.8

(51) Int. Cl. B64D 27/24; B64D 27/12; B64D 37/04; B64D 31/00; B64D 35/00; B64D 15/00; F02M 21/02; F02B 61/04; B60L 50/71; B60L 58/33; F02C 6/18; H01M 8/04858; H01M 8/04082; H01M 8/04089; H01M 8/04007

(52) U.S. Cl. CPC B64D 27/24; B64D 27/12; B64D 37/04; B64D 31/00; B64D 35/00; B64D 15/00; F02M 21/0209; F02M 21/0221; F02B 61/04; B60L 50/71; B60L 58/33; F02C 6/18; H01M 8/04932; H01M 8/04947; H01M 8/04208; H01M 8/04089; H01M 8/04007; B64D 2027/026

(57) ABSTRACT

The invention relates to a hybrid electric drive system (10) for multi-motor aircraft (20). The hybrid electric drive system comprises at least a first and a second hybrid electric drive unit (31, 32), each of which comprises: an internal combustion engine (41, 42), a motor-generator unit (71, 72) and a gear box (51, 52) for transmitting drive power to a propeller (61, 62). In order to supply the motor-generator units (71, 72) with electrical energy, the drive system (10) has a fuel cell (73), which in turn is supplied with hydrogen by means of a fuel tank (74). In the fuel cell (73), hydrogen is converted into electricity, which then supplies the motor-generator unit (71, 72) with electrical power by means of the transmission device (80) and power converters (81) and (82), in order to drive the propellers (61, 62). Advantages: On the basis of a turboprop aircraft (20) with approximately 40 to 90 passengers, approximately 40% of the energy during a 1-hour mission can be provided emission-free by means of hydrogen and fuel cell. This means no CO2 emissions at all during the cruising flight and also no climate-damaging exhaust-gas and contrail effects at cruising altitude (FL250), which are a significant share of aviation emissions.

The invention relates to a hybrid propulsion system for multi-engine aircraft, a multi-engine aircraft and a method for operating a twin-engine aircraft.

An aircraft is to be understood in particular to mean a motor-driven fixed-wing aircraft. However, the term aircraft also includes, for example, rotorcraft (rotary-wing aircraft, helicopters) and motor gliders. Aircraft and their propulsion systems can be differentiated with regard to the applicable construction and approval specifications. Specification CS-23 issued by EASA is applicable to light, fixed-wing powered aircraft. It concerns: aircraft in the normal, utility or aerobatic categories with a maximum of 9 seats (excluding pilot seat(s)) and a maximum take-off weight of 5,670 kg, and aircraft in the commuter category with a maximum of 19 seats (excluding pilot seat(s)) and a maximum take-off weight of 8,618 kg. CS-25 is likewise a construction specification issued by EASA for type approval for large aircraft, especially large, turbine-powered aircraft. In the present case, multi-engine aircraft to be certified according to the CS-25 construction specification are considered.

Regional airliners are predominantly characterized by a design with straight, non-swept wings and a cruising speed of 500 to 700 km/h. Nowadays, the turboprop engine is the main area of application for regional airliners in civil aviation. A prominent representative of this aircraft category is the Dornier 328-100 (Dornier 328 TP. 2020. Available at: https://328.eu/wp-con-tent/uploads/2020/09/D328-100.pdf [Accessed 9/28/2020]).

Turboprop (a portmanteau word, blending turbojet and propeller) is a common name for a propeller turbine air jet engine (abbreviated PTL), often simply referred to as a propeller turbine. A turboprop is a continuous internal combustion engine (thermal flow machine) and is primarily used for aircraft propulsion. Colloquially, an aircraft powered by PTL is often referred to as a “turboprop.”

This type of engine is characterized by relatively low specific fuel consumption, which is why it is primarily used in transport and short-haul aircraft. Another civilian area of application is smaller business aircraft such as the TBM-850. In the military, turboprops are primarily used in tactical transport aircraft. Turboprop aircraft are limited to flight speeds of up to 80 percent of the speed of sound (0.8 Mach), which at 8,000 m altitude corresponds to about 870 km/h under normal conditions. In this speed range, turboprops work more economically than pure turbine engines.

The turboprop engine consists of a gas turbine, which usually drives a propeller via a speed-reducing gearbox. The thrust of the engine is largely generated by the propeller—the working gas leaving the outlet diffuser contributes only a maximum of 10% to the total thrust, whereby the propulsion principle differs significantly from turbojet engines and is more similar to the turbofan. A large amount of air is moved by the propeller to generate thrust, but this is only slightly accelerated compared to turbojet engines. In the case of pure turbojet jet engines, on the other hand, significantly smaller quantities of the propulsion medium are accelerated much more strongly.

Depending on flight speed, flight altitude and load, the angle of attack of the propeller blades is changed such that both the turbine and the propeller work as consistently as possible in the optimum speed range.

The energy for driving the propeller is supplied by the gas turbine. It draws in air, which is compressed in an axial or radial, usually multi-stage, turbo compressor. It then enters the combustion chamber, where the fuel burns with it. The now hot, high-energy combustion gas flows through the mostly axial and multi-stage turbine, where it expands and cools. The energy transmitted to the turbine, on the one hand, drives the turbo compressor via a shaft and on the other the propeller via a gearbox. The exhaust gases are expelled to the rear.

The turbomachines are usually optimized for the dominant flight phase, usually the cruising phase, since this also has the highest share of energy consumption over the mission. Equal, high operating efficiency is not possible over all flight phases. While maximum efficiency for the clearly dominant cruising phase can be designed and achieved for medium- and long-haul routes, operating conditions for short- and ultra-short-haul routes are much less dominant and differ more widely. As a result, engines for regional and short-haul aircraft are operated significantly less at optimum efficiency over the entire mission and have poorer specific fuel consumption per passenger relative to short- and long-haul routes. The different drop in propulsion power and thermal efficiency also plays a role here, since a propeller aircraft, for example, flies lower and experiences lower, altitude-dependent thrust losses during cruising than a long-haul aircraft with a turbofan engine. As a result, long-haul engines run much more consistently at high power and with high efficiency operation during climb, while regional aircraft have very significantly wider power ranges, e.g., during take-off, climb and cruise.

Therefore, there are very different thrust requirements over the mission, especially for regional aircraft with propellers, but also for other twin-engine aircraft with vane wheels or rotors, which can be designed and operated more efficiently by hybridizing the thermal machines with an electric machine.

Added to this is the challenge of reducing CO2, NOX and noise emissions. Decarbonization is a major challenge for aviation. The aviation sector emits more than 900 million tons of carbon dioxide (CO2) per year. Assuming industry growth of 3 to 4 percent per year (pa) and efficiency improvements of 2 percent pa, emissions would more than double by 2050. During the same period, the aviation industry (Air Transport Action Group—ATAG) has committed to a 50 percent reduction in CO2 emissions (compared to 2005). In addition, with its Green Deal, the European Union (EU) has set itself the goal of becoming carbon neutral. Apart from CO2, aircraft influence the climate through emissions of nitrogen oxides (NOx), soot and water vapor, contrails and cirrus clouds. Their “full” contribution to global warming is therefore significantly higher than just CO2 emissions alone. (Hydrogen-powered aviation A fact-based study of hydrogen technology, economics, and climate impact by 2050, May 2020. Available from:

https://www.fch.europa.eu/sites/default/files/FCH%20Docs/20200507_Hydrogen%20 Powered%20Aviation%20report_FINAL%20web%20%281D%208706035%29.pdf [Accessed: 9/24/2020]).

The question that arises at the moment is whether electric or hydrogen-powered aircraft will be used in the future to meet the previously stated requirements. Possibly. Airbus, Rolls Royce, GE and Siemens believe they can solve the problem of reducing CO2, NOX, and noise emissions by replacing a turbofan engine with an electric motor, following the automotive industry down the road of electrically powered, or at least hybrid-powered vehicles (“Flightpath 2050 Europe's Vision for Aviation,” [Online], Available at:

https://ec.europa.eu/transport/sites/transport/files/modes/air/doc/flightpath2050.pdf. [Accessed: 3/14/2018]).

GE International is working on a corresponding hybridized turbofan propulsion system for twin-jet commercial aircraft, as the disclosure of EP 3 421 760 A1 shows. Here, an electric motor is each coupled to the high-pressure shaft of one turbofan engine and to the low-pressure shaft of the other, second turbofan engine. An electrical energy storage unit is provided to feed the electric motors, such that the electric motors can provide additional propulsion power to the coupled turbofan in certain operating states. SNECMA proposes a similar solution in publication WO 2009/153471 A2.

However, the power-to-mass density of the battery technology available today remains problematic when it comes to providing significant electrical propulsion power in concepts as described above. Put simply, current battery technology does not offer a sufficiently high energy density; moreover, the power-to-weight ratio is not high enough. For example, combustible fuels like kerosene have an energy density of about 40 MJ/kg or about 12,000 Wh/kg. The energy density of the lithium-ion batteries which powered the first E-Fan is about 60 times less. The specific energy of the batteries is thus around just 2% that of liquid fuel. As a reminder, the 167 kg batteries of the E-Fan with a mass of 600 kg lasted for about an hour of low-speed flying. In comparison, the empty weight of a Bae146 is about 24,000 kg. The numbers seem to indicate that the battery weight for an electric aircraft is 60 times the fuel weight for a current aircraft making the same flight. (‘Batteries against Fossil Fuel’, https://batteryuniversity.com/learn/archive/batteries_against_fossil_fuel (accessed: 6/17/2020).

To reduce climate impact, the industry is exploring other concepts, such as for example a radical new technology that will use sustainable aviation fuels (SAF) on a significant scale as a synthetic fuel (synfuel) temporarily in large quantities as a counterbalance or in combination. Hydrogen propulsion is one such technology.

In the 1980s, alternative fuels for jet engines were tested under real-life conditions at Tupolev as part of the further developments of the Tu-154. This resulted in the Tu-155 prototype, which was powered by liquid hydrogen or natural gas. In this three-jet machine, the right-hand engine was powered not by kerosene, but by hydrogen or natural gas. In any event, the knowledge gained from this teaches us that the conversion to hydrogen for large commercial aircraft requires a redesign with large, heavy LH2 tanks. In addition, the heavier weight of long-haul aircraft increases energy consumption and thus costs considerably.

Proceeding from this, it is the object of the invention to specify a hybrid propulsion system with which the use of internal combustion engines and, in particular, of turbomachines can be further optimized and emissions can be reduced. In addition, a multi-engine aircraft is to be specified, together with a method for operating same which optimizes the typical flight operating phases using a hybrid propulsion system.

According to the invention, the object relating to the propulsion system is achieved by a propulsion system having the features of claim 1.

Advantageous embodiments of the invention for the hybrid propulsion system result from subclaims 2 to 11, the description and the attached drawing. With regard to the multi-engine aircraft and the method for operating same, advantageous variants can be derived from claims 12 to 17 and 18.

The propulsion system according to the invention for multi-engine aircraft is based on a specific propulsion system architecture using two different energy sources or fuels, which enables emission-free operation of an aircraft over essential phases of a typical mission (zero emission cruise). Due to the specific system architecture and the combination of two energy sources, the impact of the new technology and energy sources on today's aircraft configurations already in service is minimized and much earlier deployment is enabled compared to the current zero-emission system proposals.

An essential aspect of the invention is the design of such a system based on a desired mission and the overall architecture of the aircraft. Dimensioning and representation of the required efficiency is not possible without considering the entire aircraft system.

An essential component of this invention is an aircraft architecture which enables ‘zero emission’ cruising and thus also eliminates the aviation-specific non-CO2 emissions in high air layers. In the claims, the invention describes a solution to the issue of how the high thrust requirement in the starting phase is divided between two energy sources and thus the dimensioning of the emission-free propulsion system in terms of weight and volume can be integrated into an existing aircraft platform using existing technology. The invention also discloses a solution for an overall aircraft system with the essential elements of a hybrid propulsion system, fuel cell system, a hydrogen tank system and an open and closed-loop control unit.

The overall system in question consists of a propulsion system with two different energy sources. The propulsion system consists of two electro-hybridized internal combustion engines or turbomachines or other thermal combustion machines, each coupled with a propulsor and a special closed- and open-loop control unit for thermal and electrical machines. The energy sources take the form on the one hand of fuels compatible with standard refueling, standard aviation fuel or decarbonized, synthetic or biofuels (SAF), and of hydrogen for the supply of a fuel cell system. In principle, the benefit of the invention is that long flight phases can be flown without emissions. It is important to consider both CO2 and non-CO2 emissions. In particular, the climate-damaging greenhouse effects due to combustion at high altitudes are taken into account.

In order, with this system, to achieve the goal of emission-free cruising and at the same time the early likelihood of application, the dimensioning of the system and the use of the two energy sources over the mission are essential to ensure compatibility with today's aircraft concepts. There are at least two important factors:
the amount of hydrogen and the resulting tank volume should have no effect on the aerodynamic surface area (no additional drag and thus loss of performance);
the performance of the fuel cell system is primarily adapted to cruising, therefore limited use for cruising and descent constitutes an optimization of use without having to combine additional heavy electrical power energy sources, such as batteries or supercaps (any increase in fuel cell system performance has an exponential effect on system weight and cooling requirements).

In summary, the propulsion system enables the use of new technologies for aviation within the next decade but based on prospects that can be assessed today:
1. Applicability to current aircraft designs (wings—fuselage, with significant changes that can, however, be assessed today). For example, continued use of the wing as a fuel tank for internal combustion engines is essential.
2. Fundamentally transferable and therefore applicable approval rules at aircraft level. Verification of new technologies and energies, but conformity to the basic requirements.
3. Use of the aircraft even without hydrogen and fuel cell system with the given system design, e.g., in regions without hydrogen infrastructure.
4. Limitation of system impact due to adaptability in the use of the two energy sources.
5. Use of the fuel cell system as a continuous energy source.
6. Increased operational safety in the event of a safety-relevant failure of a thermal machine or energy source.
7. Combustion of fuel in internal combustion engines substantially not at cruising altitude, or only for a short time window, thus also avoiding climate-damaging greenhouse effects.

Regarding the main goal, the reduction of emissions, CO2 and non-CO2 emissions resulting from the concrete example of the turboprop Do328 can be reduced with this system architecture and specific energy use over the mission. As a reference, a system design is taken as basis which involves a mission of one hour and exhibits energy use as follows:
a) Thermal combustion engine with sustainable, CO2-neutrally produced fuel (SAF) primarily for take-off, climb, approach and landing.
b) Hydrogen/fuel cell system for cruise and descent.

The energy requirement for this reference mission results in a split of approx. 60% for synthetic fuel (a) and 40% for hydrogen (b). In simplified terms, this is based on the fact that the overall efficiency of the thermal machines is approximately the same as that of the fuel cell system, including cooling and the necessary electrics. This assumption can of course vary depending on the integration factor and the individual state of the art, but this is in the range of approx. 5% to 10%. This affects the detailed split of CO2-neutral and zero-emission flight. From today's point of view, the technological prospects suggest that there is more potential in improving the efficiency of fuel cell systems compared to the improvement potential of a turboprop propulsion system.

Emission reduction summary:
On the basis of a turboprop aircraft with approx. 40 to 90 passengers, around 40% of the energy during a 1-hour mission can be produced emission-free using hydrogen and fuel cells. This means no CO2 emissions during cruising and no climate-damaging exhaust gas effects and contrails at cruising altitude (FL 250), which represent a significant proportion of aviation emissions.
Furthermore, the combustion share of approx. 60% can be produced CO2-neutrally by switching from conventional fuel to synthetic fuels. This aircraft and system architecture thus enables a 100% decarbonized and CO2-neutral flight and around 40% emission-free flight with regard to CO2, greenhouse gas and contrail effects at cruising altitude.

This architecture can be implemented in two different variants:
a) Thermal machine performance is designed for carrying out take-off, climb and landing, with the fuel cell system being used exclusively for cruising and descent. The required tank volume for hydrogen is thus minimized in order to optimize the possibilities of integration into the aircraft. The aircraft retains the basic ability also to be operated without hydrogen and a fuel cell system.
b) Support for the internal combustion engines during take-off, climb and landing by expanding the use of the fuel cell system in order to achieve a reduction in the power requirement of the thermal engines (downsizing). This means that smaller internal combustion engines can be used. This results in a further increase in emission-free flight share to approx. 70% by reducing the share of mission block energy from fuel combustion. It is necessary to adapt the hydrogen tank volume to the increased energy demand.

In general, the invention relates to propulsion systems for small and large transport aircraft (CS-23 and CS-25) with twin-engine drives (piston machines or turbomachines) that convert thermal energy into mechanical drive shaft power and a propulsor (propeller, vane wheel, rotor) to generate thrust. Implementation in primarily propeller-driven regional aircraft in a size class of around 30 to 90 passengers appears to be the most economical. This corresponds to a power at the propeller shafts (total of all propeller shafts—total power) of around 3,000 kW to 8,000 kW.

The following factors are taken into account with regard to the feasibility of this architecture, in particular also the possibility of integration into today's aircraft architectures:
Energy requirement in the various flight phases
Power requirements in the various flight phases
Optimized split between thermal combustion/fuel use
and electrical energy/hydrogen use
Hydrogen weight and tank volume
Overall system and component weights
Thermal and electrical efficiency of fuel cell system

When considering the feasibility of this invention for certain aircraft classes, technological prospects achievable from today's perspective with regard to performance and maturity are taken as basis.

Of course, the applicability of this system architecture can be extended to higher power classes and aircraft sizes with changes in technological prospects and timing of introduction.

The following technology values are used as a reference:
Overall efficiency of fuel cell system: 50%
Total fuel cell system weight: 1500 kg (including electric drive)

With regard to liquid hydrogen storage tanks, tanks with a gravimetric index of 20 percent or higher should be aimed for. The gravimetric index of a tank is calculated by dividing the mass of the stored hydrogen by the sum of the mass of stored hydrogen and the weight of the empty tank. A gravimetric index of 50 percent means that the empty tank weighs the same as the stored hydrogen.

Essentially, at least four significant advantages can be achieved by the invention compared to the propulsion systems known from the known prior art:
a) Reduction in fuel consumption through optimized use of the internal combustion engine adapted to the various flight phases. Hybridization of the propulsion units, which involves a variably switchable electric motor-generator unit on a common gearbox, is of essential importance. Through a gradual transition of propulsion power by way of the electric machine, the latter can take over the power from the thermal machine on transition from climb to cruising.
b) The gearbox plays a further role in the propulsion system according to the invention, its input shafts enabling a respectively optimized speed range for both the thermal machine and the electric machine, in order to optimally output the torque to the propulsor shaft. This enables a weight-optimized design and loss-optimized operating states for both the electrical and thermal machines.
c) Another important aspect of the invention is the reduction in operating times of the thermal machines over the flight hours, so reducing maintenance costs and extending maintenance intervals. In general, electric machines of the same power rating require lower maintenance effort and expenditure because the electric motor-generator unit typically has no ‘hot’ components.
d) Finally, the propulsion system allows an increase in safety in the event of a “single engine failure”. Especially in the critical flight phases of take-off, first climb phase and landing approach (take-off, initial/climb and approach) the missing power can immediately be distributed again symmetrically to both sides via the electrical machines.

Compared to the high-capacity, battery-based hybrid concepts currently under development, the result is a significantly weight-optimized design, since current battery concepts still only have a low specific energy density.

The required redundancy is generated by the two propulsion units including electric motor generator units. Both propulsion units have the same performance and act with the same thrust over the entire mission profile. The main dimensioning error case—complete failure of a propulsion unit—is taken into account in the design of each propulsion unit and allows maneuvering of the aircraft in every phase of flight with specified limitations until a safe landing is achieved.

Thrust adjustments over the flight mission are made to the same extent by both propulsion units and optionally with additional, active blade adjustment. Turbomachines are usually optimized for the dominant flight phase, primarily during the cruise phase, since this also represents the largest share and energy consumption over the mission. Equal, high operating efficiency is not possible overall flight phases. While maximum efficiency for the clearly dominant cruising phase can be designed and achieved for medium- and long-haul routes, operating conditions for short- and ultra-short haul routes are much less dominant and varied. As a result, engines for regional and short-haul aircraft are operated significantly less at optimum efficiency over the entire mission and have poorer specific fuel consumption per passenger relative to short- and long-haul routes.

The different drop in propulsion power and thermal efficiency also plays a role here, since a propeller aircraft, for example, flies lower and experiences lower, altitude-dependent thrust losses during cruising than a long-haul aircraft with a turbofan engine. As a result, long-haul engines run much more consistently at high power and with high efficiency operation, both during climb and cruise, while regional aircraft have much wider power ranges, e.g., during take-off, climb and cruise.

Therefore, there are very different thrust requirements over the mission, especially for regional aircraft with propellers, but also for other twin-engine aircraft with vane wheels or rotors, which can be designed and operated more efficiently by hybridizing the thermal machines with an electric machine.

While previous hybrid propulsion systems and architectures for aircraft have had the goal of integrating additional or a different arrangement of propulsion power elements (propellers, rotors, vane wheels) or additional, alternative energy sources such as batteries or fuel cells, this invention achieves higher efficiency without additional propulsor or energy sources. In contrast to previous hybrid concepts, such as the arrangement of several propulsors distributed over the span of the wing to generate better lift at low speeds, which is a significant additional weight for an advantage during the short flight phases on take-off and landing, or the use of energy systems whose power density is not currently sufficient for larger aircraft, the propulsion system of this invention can be implemented with today's technology and aircraft concepts with significant advantages.

The operating hours of the individual thermal machines, assuming a uniform, alternating operation during cruise and descent, can be reduced by approx. 30% (as a reference a 60 min mission), which translates one-to-one into an extension of the maintenance intervals and a reduction in maintenance costs of the thermal machines.

The propulsion architecture described in this invention can also be dimensioned and integrated as a retrofit variant for existing aircraft.

Further features, advantages and effects of the invention result from the following description of preferred exemplary embodiments of the invention, as shown in the drawings. In the figures:

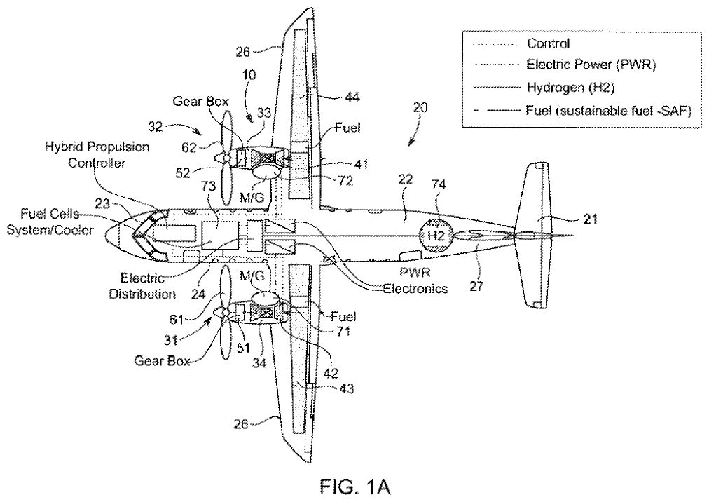

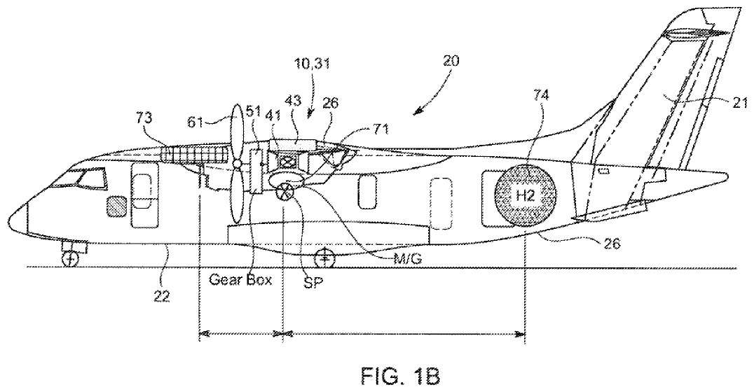

FIG. 1a shows a plan view of a twin-engine aircraft with a schematic representation of a hybrid propulsion system,

FIG. 1b shows a side view of the twin-engine aircraft according to FIG. 1a with a schematic representation of a hybrid propulsion system,

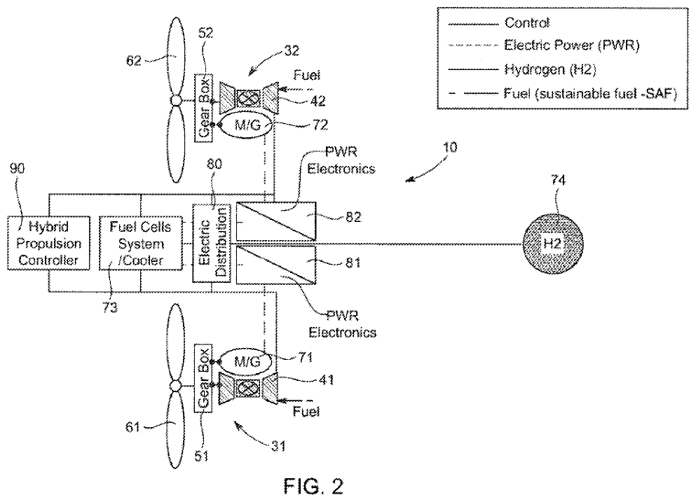

FIG. 2 shows a system diagram of a hybrid propulsion system with a schematic representation of the system architecture,

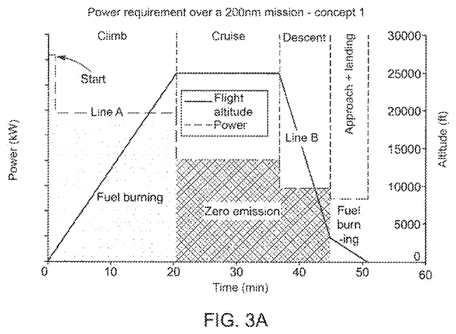

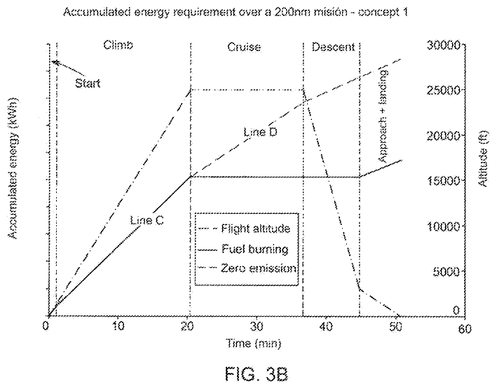

FIG. 3a shows a diagram of the power requirement and flight altitude during the operating phases of a typical 200 NM mission by an aircraft with conventional gas turbines and electric motor-gearbox units,

FIG. 3b shows a diagram of the accumulated energy requirement during the operating phases of a typical 200 NM mission by an aircraft with conventional gas turbines and electric motor-gearbox units,

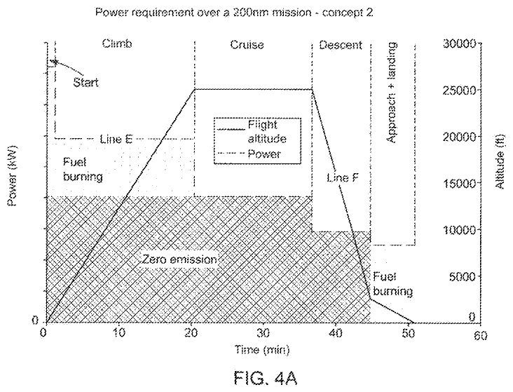

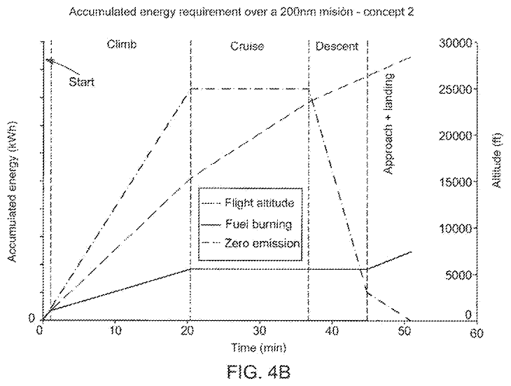

FIG. 4a shows a diagram of the power requirement and flight altitude during the operating phases of a typical 200 NM mission by an aircraft with smaller gas turbines and electric motor-gearbox units,

FIG. 4b shows a diagram of the accumulated energy requirement during the operating phases of a typical 200 NM mission by an aircraft with smaller gas turbines and electric motor-gearbox units,

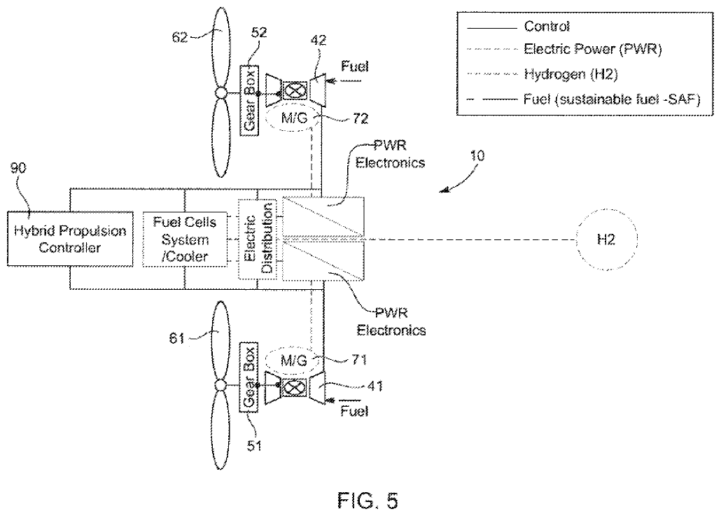

FIG. 5 shows a system diagram of a hybrid propulsion system with a schematic representation of the system architecture in the primary operating mode, and

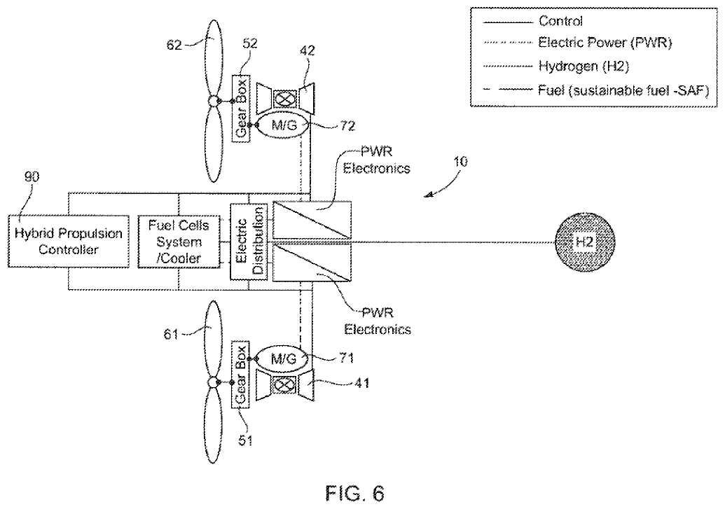

FIG. 6 shows a system diagram of a hybrid propulsion system with a schematic representation of the system architecture in the third operating mode.

A typical installation configuration of a hybrid propulsion system 10 for a twin-engine regional aircraft 20 is shown in FIG. 1a and FIG. 1b, taking the Dornier 328-100 as example.

The aircraft 20 takes the form of a conventional high-wing aircraft with a T-tail unit 21 at the rear. The fuselage 22, which is cylindrical in sections, is designed with a pressurized cabin in which the cockpit 23 and the passenger compartment 24 are accommodated. At the rear, the pressurized cabin is closed in pressure-tight manner by a pressure bulkhead. Further aft, the fuselage 22 tapers conically and carries the T-tail unit 21. In the Dornier 328-100, known from the prior art, one of the luggage compartments is provided in the conical transition area.

In a conventional high wing configuration, the wings 26 are attached to the fuselage tube, at an overhead tangent thereto. The hybrid-electric propulsion units 31 and 32 are accommodated in the engine nacelles 33 and 34, of which one is attached to each of the left and right wings 26. The multi-bladed and adjustable propellers 61, 62 are driven via reduction gearboxes likewise integrated in the engine nacelles 33 and 34. To avoid undesirable icing phenomena on the propeller blades, these can be heated electrically, the propeller blades receive the power for heating from a transmission device 80.

The system architecture of the propulsion system 10 integrated in a two-engine aircraft 20 in FIG. 1a can be seen in further detail in FIG. 2. The propulsion system 10 comprises two hybrid-electric propulsion units 31 and 32 that can be operated independently of one another. Each hybrid-electric propulsion unit 31, 32 has a gas turbine 41, 42 with flange-mounted reduction gearbox 51, 52, via which in each case a propeller 61, 62 with variable pitch adjustment is coupled. Corresponding gas turbines 41, 42 with integrated reduction gearbox 51, 52 are available, for example from Pratt & Whitney Canada under the designation PW 119C. In the wings 26, left and right wing integral tanks 43, 44 are formed, which supply the two gas turbines 41, 42 with fuel via fuel lines and systems not described in any greater detail.

Assigned to each propulsion unit 31, 32 is a motor-generator unit 71, 72, each of which are coupled to the reduction gearbox 51, 52 on the propulsion side. Depending on the operating phase, the motor-generator unit 71, 72 can be operated as an electric motor or as a generator. In propulsion mode, the motor-generator unit 71, 72 transmits propulsion power via the reduction gearbox 51, 52 to the respective associated propeller 61, 62. In generator mode, the motor-generator unit 71, 72 generates electrical power, which is fed to a transmission device 80 for further distribution or storage. Two power converters 81 and 82, one of which is in each case assigned to each motor-generator unit 71, 72, constitute a functional component of the transmission device 80.

In order to supply the motor-generator units 71, 72 with electrical energy, the propulsion system 10 has a fuel cell 73, which is in turn supplied with hydrogen via a fuel tank 74. In the fuel cell 73, hydrogen is converted into electricity, electric power then being supplied via the transmission device 80 and power converters 81 and 82 to the motor-generator units 71, 72 to drive the propellers 61, 62. Currently most advanced and best suited to aviation are low-temperature proton exchange membrane fuel cells (PEM fuel cells). The addition of an optional energy storage device such as a battery to this system helps ensure rapid load follow-up and power peak shaving to optimize fuel cell system dimensioning.

In general, hydrogen can be stored as a pressurized gas or in liquid form. While gaseous storage may be suitable for shorter flights and is commercially available, the invention focuses on liquid hydrogen (LH2) storage tanks as they require about half the volume and are consequently significantly lighter than gaseous hydrogen tanks. Since LH2 must remain cold and heat transfer must be minimized to avoid hydrogen vaporization, spherical or cylindrical tanks are required to keep losses low. In the configuration shown in FIG. 1a and FIG. 1b, the spherical fuel tank 74 is accommodated in the conical rear fuselage 27, which can be used as a cargo hold when the fuel tank 74 is removed.

The units consisting of controller 90, transmission device 80 and fuel cell 73 are arranged in a bow-side area of the fuselage 22 in front of the wing and outside the pressurized cabin. The units and the fuel tank 74 for supplying the fuel cell 73 form a moment equilibrium that is essentially neutral with respect to the center of gravity SP of the aircraft 20 (see FIG. 1b).

In a secondary function, the waste heat removed from the fuel cell 73 by means of a cooling unit serves to de-ice exposed surfaces of the aircraft 20, such as the wing leading edges, air inlets of the gas turbines 41, 42 and leading edges of the T-tail.

A central controller 90, which is connected to power converters 81 and 82 and the gas turbines 41, 42, is provided for controlling the thermally and electrically generated propulsion power. On the one hand, depending on operating phase, the controller 90 controls the motor-generator unit 71, 72 via the power converters 81 and 82, the delivery of electrical propulsion power and the electrical energy to be generated, and on the other hand the thermally generated propulsion power of the gas turbines 41, 42. Typical controller 90 parameters to be controlled and monitored are the fuel supply, the speeds of the power and high-pressure shaft and the turbine temperature of the gas turbines 41, 42.

In a further embodiment, an architecture is shown in FIG. 2 which is based on a DC voltage network 101 and AC/DC converters 81, 82. Depending on the operating mode and power requirement, the power output of the fuel cell 73 can be fed via the transmission device 80 and the AC/DC converters 81, 82 to the first and second motor-generator units 71 and 72, respectively, and the propulsion power can be transmitted via the reduction gearboxes 51 and 52 to the propellers 61 and 62, respectively.

Taking a Dornier 328 as example, the diagram in FIG. 3a shows the difference for cruising between an aircraft 20 with a propulsion system 10 according to the invention and the prior art, taking a Dornier 328 equipped with two conventional engines as an example. The maximum power of the thermal engines is designed to carry out take-off and landing, with use of the fuel cell system being intended exclusively for cruising and descent. The required tank volume for hydrogen is thus minimized in order to optimize the possibilities of integration into the aircraft. The diagram in FIG. 3a shows the power requirement in kW and flight altitude in ft over time for a typical 200 NM flight mission. The most important phases of a typical flight mission are explained below:

Take-off:

Take-off is the phase of flight in which the aircraft 20 makes the transition from moving along the ground (taxiing) to flying in the air, typically starting on a runway. As a rule, the engines are operated at full power during take-off.

Climb:

After take-off, the aircraft climbs to a certain altitude (in this case 25,000 ft) before flying safely and economically to its destination at that altitude.

Cruising:

Cruising is the portion of air travel where flying is at its most fuel efficient. It takes place between the ascent and descent phases and usually constitutes the majority of a journey. Technically, cruising is performed at constant airspeed and altitude. Cruising ends as the aircraft approaches its destination, with the descent phase starting in preparation for landing. In most commercial passenger aircraft, the cruising phase consumes most of the fuel.

Descent:

The descent during a flight is the portion where an aircraft loses altitude. The descent is an essential part of the landing approach. Other partial descents may serve to evade traffic, avoid bad flight conditions (turbulence or bad weather), avoid clouds (especially under contact flight rules), enter warmer air (if there is a risk of icing), or take advantage of the wind direction at a different altitude. Normal descents take place at constant airspeed and constant descent angle. The pilot controls the angle of descent by varying engine power and angle of attack (nose-down) to maintain airspeed within the specified range. At the start and during the descent phase, the engines will be operated at low power.

Approach & Landing:

Approach and landing are the final part of a flight when the aircraft returns to the ground. For landing, the airspeed and the rate of descent are reduced to the extent that a specified glide path (3 degree final approach at most airports) to the touchdown point on the runway is maintained. The reduction in speed is achieved by reducing thrust and/or creating greater drag using flaps, landing gear or air brakes. As the aircraft approaches the ground, the pilot performs a landing flare to initiate a soft landing. Landing and approach procedures are mostly carried out using an instrument landing system (ILS).

Line A (dashed): Power requirement of the propulsion system 10 over the mission with two hybrid-electric propulsion units 31, 32. The power requirement is highest during take-off and reduces over the subsequent flight phases. The power requirement for the flight phases take-off, climb and approach and landing is served by the gas turbines 41, 42 alone (“primary operating mode”). When cruising and descending, propulsion is provided by the motor-generator units 71, 72 supplied by the fuel cell 73 (‘third operating mode’). During flight, the controller 90 controls operation of the propulsion units 31, 32 and the transitions from primary to secondary mode of operation and vice versa. The dotted area under line A represents the consumption of fuel by the gas turbines 41, 42 and the checkered area the consumption of hydrogen by the motor-generator units 71, 72 during the operating phases. The energy requirement for this reference mission results in a split of approx. 60% for fuel (SAF) and 40% for hydrogen.

Line B (solid) describes the flight altitude in ft over the time of the mission. The flight altitude is highest during cruising and is about 25,000 ft.

In the diagram according to FIG. 3b, the associated accumulated energy requirement is shown by the solid and dashed lines C and D during the aforementioned operating phases and operating modes. Line C represents the energy requirement during the primary operating mode, and line D, during the third operating mode.

The diagrams of FIG. 4a and FIG. 4b represent the values for a second variant of the invention. Here, the internal combustion engines are supported during take-off and landing by extending the use of the fuel cell system in order to achieve a reduction in the power requirement of the thermal machines (downsizing). In this case, combined operation and power output of gas turbines 41 and 42 and motor-generator units 71, 72 takes place, coordinated by controller 90 (‘secondary operating mode’). One advantage is that smaller internal combustion engines can be used. This results in a further increase in the proportion of a flight which is emission-free to approximately 70% (checkered area in FIG. 4a).

Line E (dashed): The power requirement of the propulsion system 10 over the mission with two hybrid-electric propulsion units 31, 32 according to FIG. 4a is in principle the same as shown in FIG. 3a. Here, too, the power requirement is highest during take-off and reduces over the subsequent flight phases.

Line F (solid) describes the flight altitude in ft over the time of the mission. The flight altitude is highest during cruising and is approximately 25,000 ft, as in FIG. 3a.

The diagrams in FIG. 3a and FIG. 3b clarify an essential aspect of the invention, namely that for many aircraft, in particular for regional aircraft with propeller propulsion, the required thrust for take-off is significantly higher than for cruising and the thermal machines are therefore only operated at around half of their capacity over a large proportion of the flight mission. This means that conventional turboprop propulsion systems are operated outside of the optimum operating point, which is closer to the point of maximum power output. In contrast, a hybrid-electric propulsion system can be optimized for the two different operating modes.

With regard to the operating phases of the propulsion system 10, the following basic operating states result:
1. FIG. 5 shows a system diagram for take-off, climb and approach/landing. Both gas turbines 41 and 42 are in operation and drive the propellers 61, 62 via the interposed reduction gearboxes 51, 52 (solid lines). Thrust control takes place centrally via hybrid propulsion controller 90 to gas turbines 41 and 42 (‘primary operating mode’). The electric motor-generator units 71 and 72 do not produce any propulsion power (dashed lines).
2. The secondary mode of operation for take-off and climb is shown in FIG. 2. In this combined operating mode, the propulsors (61, 62) receive propulsion power from both the first and second internal combustion engines (41, 42) and from the first and second motor-generator units (71, 72). The associated power requirement and cumulative energy consumption can be seen in the diagrams in FIG. 4a and FIG. 4b. The reduced fuel consumption for the gas turbines due to the additional propulsion power from the electric motor-generator units 71, 72 becomes clear here.
3. The system state for cruising and descent can be seen in FIG. 6. The power/torque requirement drops to cruising level (FIGS. 3a and 4a) and the power of the two gas turbines 41, 42 is reduced while the propulsion power from the two motor-generator units 71, 72 can be transmitted to both propellers 61 and 62 in an equally distributed manner via the coupled gearboxes 51, 52. During cruising and subsequent descent, the thrust requirement is adjusted via the hybrid propulsion controller 90. This is responsible for thermal and electrical control (‘third operating mode’).
4. The system architecture according to the invention enables a symmetrical thrust due to the power distribution over the electrical network even in the case of a critical fault, failure of an internal combustion engine. On the side of the failed internal combustion engine 41, 42, the motor-generator unit 71 or 72 can be switched on and thus at least part of the failed thrust can be compensated.

### LIST OF REFERENCE SIGNS

10 Propulsion system
20 Aircraft
21 T-tail
22 Fuselage
23 Cockpit
24 Passenger cabin
26 Wings, left and right
27 Fuselage tail
31, 32 Propulsion units, left and right
33, 34 Engine nacelles, left and right
41, 42 Gas turbines, left and right
43, 44 Wing integral tanks, left and right
51, 52 Reduction gearboxes, left and right
61, 62 Propellers, left and right
71, 72 Motor-generator units, left and right
73 Fuel cell
74 Fuel tank
80 Transmission device
81, 82 Power converters
90 Controllers
A, B, C, D, E, F Lines
SP Center of gravity

1. A hybrid propulsion system for multi-engine aircraft having:
at least one first and one second hybrid-electric propulsion unit, each having an internal combustion engine and a motor-generator unit for transmitting propulsion power to a propulsor,
wherein the propulsor can be coupled to the internal combustion engine and/or the motor-generator unit for the transmission of propulsion power,
the first and second motor-generator units are connected to a transmission device for distributing electric power,
a fuel cell for supplying the first and/or second motor-generator unit with electrical energy,
a controller for controlling the thermally and electrically generated propulsion power is connected to the internal combustion engines and/or the transmission device and/or motor-generator units and/or the fuel cell,
separate fuel tanks for supplying the internal combustion engines with fuel or the fuel cell with cryogenic hydrogen.

2. The propulsion system according to claim 1, characterized in that in the hybrid-electric propulsion unit:
in a primary operating mode, the propulsors receive the propulsion power predominantly or entirely from the internal combustion engines,
in a secondary, combined operating mode, the propulsors receive the propulsion power from the first and second internal combustion engines and from the first and second motor-generator units, and
in a third operating mode the propulsors receive the propulsion power from the first and second motor-generator units.

3. The propulsion system according to claim 1, characterized in that, in the operating modes, the controller brings about symmetrical distribution of the propulsion power to the propulsors.

4. The propulsion system according to claim 1, characterized in that the electrical propulsion power of the first or second motor-generator unit can be variably switched on on transition between the operating modes.

5. The propulsion system according to claim 1, characterized in that the hybrid-electric propulsion units each have a gearbox for transmitting the propulsion power, wherein the internal combustion engine and the motor-generator unit can be coupled to the propulsor by means of the gearbox.

6. The propulsion system according to claim 1, characterized in that the change in the transmission of the propulsion power of the internal combustion engine and the propulsion power of the motor-generator unit takes place successively in such a way that the propulsion power output to the propulsor of the common propulsion unit remains approximately the same.

7. The propulsion system according to claim 1, characterized in that the propulsors are designed as propellers with blade adjuster and the controller for controlling the propulsion power is connected to the blade adjuster.

8. The propulsion system according to claim 1, characterized in that in a further operating mode the propulsion power of the first or second internal combustion engine has failed completely or predominantly and the first or second motor-generator unit is provided with electrical power by the fuel cell via the transmission device.

9. The propulsion system according to claim 1, characterized in that the transmission device takes the form of an AC network.

10. The propulsion system according to claim 1, characterized in that the transmission device takes the form of a DC network, each motor-generator unit being assigned an AC/DC converter which is connected to the controller to control the speed of the propulsor.

11. The propulsion system according to claim 1, characterized in that the internal combustion engines are operated with sustainable aviation fuel.

12. A multi-engine aircraft having a hybrid propulsion system according to claim 1, a wing accommodating the propulsion units and a fuel tank, and a fuselage, characterized in that the propulsion unit is formed of a turboprop engine with in each case one gas turbine which can be coupled to a speed-reducing gearbox to drive a propeller, wherein the motor-generator unit can be coupled to the gearbox in a controlled manner via the controller, depending on operating mode.

13. The multi-engine aircraft according to claim 12, characterized in that at least the predominant volume of the fuel tanks for supplying the internal combustion engines is integrated in the wing and at least the predominant volume of the fuel tanks for supplying the fuel cell is integrated in a rear area of the fuselage.

14. The multi-engine aircraft according to claim 12, characterized in that the fuselage has a space in a rear area for forming a cargo hold, in which the fuel tank for supplying the fuel cell is arranged.

15. The multi-engine aircraft according to claim 12, characterized in that units consisting of a controller and/or transmission device and/or fuel cell are arranged in a bow-side area of the fuselage.

16. The multi-engine aircraft according to claim 15, characterized in that the units and the fuel tank for supplying the fuel cell form a moment equilibrium which is essentially neutral with respect to the center of gravity (SP) of the aircraft.

17. The multi-engine aircraft according to claim 12, characterized in that the fuel cell has a cooling unit, the waste heat being used to de-ice exposed surfaces of the aircraft.

18. A method for operating a multi-engine aircraft according to claim 12, characterized in that the propulsion system is operated in a primary, secondary and in a third operating mode, wherein:
taxiing of the aircraft, in particular on aprons and taxiways, takes place in the primary or third operating mode,
take-off and climb to cruising altitude take place in the primary or secondary operating mode,
cruising and descent to approach altitude take place in the secondary or third operating mode,
approach and landing take place in the primary or secondary mode of operation, and
if an internal combustion engine fails, the flight continues in the secondary or third operating mode.
